(19) United States
(12) Patent Application Publication
(10) Pub. No.: US 2008/0226154 A1
(43) Pub. Date: Sep. 18, 2008

(54) SYSTEMS AND METHODS FOR PRODUCING CARBONACEOUS PASTES USED IN THE PRODUCTION OF CARBON ELECTRODES

(75) Inventors: Jay N. Bruggeman, N. Charleston, SC (US); Angelique Adams, Knoxville, TN (US); David Coleman, Murrysville, PA (US); Robert A. Blake, Apollo, PA (US)

Correspondence Address: INTELLECTUAL PROPERTY, ALCOA TECHNICAL CENTER, BUILDING C, 100 TECHNICAL DRIVE, ALCOA CENTER, PA, 15069-0001, US

(73) Assignee: Alcoa Inc., Pittsburgh, PA (US)

(21) Appl. No.: 12/046,013

(22) Filed: Mar. 11, 2008

Related U.S. Application Data
(60) Provisional application No. 60/895,396, filed on Mar. 16, 2007.

(51) Int. Cl. G06K 9/00

(52) U.S. Cl. 382/141

(57) ABSTRACT

Systems and methods for producing a carbonaceous paste are provided. The systems and methods may include a paste control system that obtains an image of the carbonaceous paste and determines whether operational parameters associated with paste production require adjustment. One or more operational variables may be adjusted based on the obtained images to facilitate production of the carbonaceous paste.

### CROSS-REFERENCE TO RELATED APPLICATION

This patent application claims priority to U.S. Provisional Patent Application No. 60/895,396, filed Mar. 16, 2007, and entitled, “SYSTEMS AND METHODS FOR PRODUCING CARBONACEOUS PASTES USED IN THE PRODUCTION OF CARBON ELECTRODES”, which is incorporated herein by reference.

### FIELD OF THE INVENTION

Systems and methods for producing carbonaceous pastes used in the production of carbon-based electrodes are provided. In one aspect, an image of the paste is obtained and data associated therewith is analyzed to evaluate the paste.

### BACKGROUND OF THE INVENTION

Carbon-based electrodes are often produced by mixing coke with pitch to form a paste. This paste is then formed and baked to produce the carbon electrode. Electrode properties vary with the coke to pitch ratio. Since coke quality can vary greatly, it can be difficult to evaluate the amount of pitch that should be used for a given amount of coke. One conventional technique for producing pastes is to measure the physical properties of the coke and pitch (e.g., mass, density) and then estimate about how much pitch should be used relative to a given amount of coke. Feedback for this method of producing carbon pastes takes a long time to obtain since it is not generally known whether the estimated ratio of coke to pitch will result in a suitable electrode until a sample of the fully baked electrode can be taken (e.g., about 30 days). Since it takes about one month to produce a fully baked electrode, significant time and materials may be wasted due to inaccurate estimations.

There exists a need for improved methods and systems for producing carbon electrodes.

### SUMMARY OF THE INVENTION

In view of the foregoing, a broad objective of the present invention is to provide for improved systems and methods of producing carbon electrodes.

Another objective is to facilitate evaluation of pastes utilized to produce carbon electrodes prior to baking the paste.

A related objective is to facilitate more consistent production of pastes suitable for production of carbon based electrodes.

In addressing one or more of the above objectives, the present inventors have recognized that imaging technology can be utilized to facilitate paste production. More particularly, the present inventors have recognized that imaging technology may be utilized to evaluate one or more of the carbon paste, the particulate carbon feed stream (e.g., the coke feed stream), the carbon binder feed stream (e.g., the pitch feed stream), or the green carbon electrode. In one implementation, one or more images relating to the carbon paste production process are obtained, these images are analyzed to produce image characteristic data, and the image characteristic data is utilized to evaluate the paste (e.g., predict whether the paste will result in a suitable electrode).

In one aspect, systems for manufacturing a carbonaceous paste for use in producing carbonaceous electrodes are provided. In one approach, the system includes a mixer that is adapted to mix and contain a carbonaceous paste, and a paste control system. The carbonaceous paste may include a particulate carbonaceous material and a carbonaceous binder. The particulate carbonaceous material may be any suitable carbonaceous material. In one embodiment, the particulate carbonaceous material comprises at least one of petroleum coke and recycled electrode materials. In one embodiment, the carbonaceous binder comprises carbonaceous pitch.

The paste control system may include an imaging device operable to obtain an image of the carbonaceous paste, an image processor operable to process the image and output image characteristic data, and a data analyzer operable to analyze the image characteristic data and provide an output relating to the paste (e.g., a predicted physical property of the paste). A display may also be used for displaying this output and/or the image characteristic data itself.

The imaging device may be any suitable device adapted to obtain an image of the carbonaceous paste. For example, the imaging device may include a digital photographic device. In turn, the image may be in a binary format. In one embodiment, the digital photographic device comprises the image processor. For example, the imaging device may be a digital photographic device including an integrated processor capable of analyzing the image and automatically outputting image characteristic data based on the obtained image.

The image characteristic data may be any data relating to the obtained images. In turn, the image may be in a binary format. In one embodiment, the image analyzer may perform a blob analysis to obtain image characteristic data. The blob analysis may result in the identification of and/or analysis of one or more distinct regions (blobs) within the image. The characteristics of these distinct regions may be a part of the image characteristic data and may be utilized to facilitate output relating to the paste. For example, the blob analysis may result in the identification of one or more regions (blobs) within an image that indicate the presence of particles. In this regard, one or more of the blob dimensions (e.g., length, width, feret diameter(s)), the blob area, the blob perimeter, and the blob shape (e.g., compactness, roughness, hole(s)), among others, may be determined to approximate the size, shape and/or reflectivity/absorptive qualities of the particle(s) in the paste. Data relating to the relative location of identified blobs with respect to one another can also be utilized. The blob analysis may also/alternatively be employed with respect to non-particulate areas of the image(s). Aside from blob analysis, other image analysis could be utilized to determine image characteristic data, such as pattern matching, pixel distribution(s), pixel value(s), pixel profile(s), edge location(s), and edge painting, to name a few.

The data analyzer may analyze one or more of the image characteristic data to facilitate evaluation of the paste. In one embodiment, various one(s) of the image characteristic data are correlated to form one or more paste prediction model(s) and/or to output one or more predicted paste parameter(s). The paste prediction model may be a model that employs image characteristic data to evaluate the paste. In one embodiment, the paste prediction model uses image characteristic data to output the predicted paste parameter(s). In one embodiment, image characteristic data from a plurality of images are correlated to form the paste prediction model and/or output the predicted paste parameter(s). In a particular embodiment, at least some image characteristic data derived from a blob analysis are utilized to form the paste prediction model and/or output the paste prediction parameter(s). The data analyzer may thus utilize image characteristic data to evaluate the paste and output a predicted paste parameter (e.g., a physical characteristic of the paste). In one embodiment, the predicted paste parameter is a predicted percentage of binder in the carbonaceous paste. In turn, the paste prediction parameter(s) may be evaluated to determine whether the paste is suitable, for example, by comparing predicted physical properties of the paste, as obtained from the paste prediction model, to desired physical properties of the paste.

The system may include other components. In one embodiment, the paste control system comprises a light source adapted to directed light toward the carbonaceous paste. In one embodiment, the light source directs one or more of ultraviolet, visible and/or infrared light toward the carbonaceous paste. Hence, the directed light may have a wavelength of from about 280 nm to about 1,000 nm. In one embodiment, the paste control system comprises an indicator for indicating whether paste operating conditions should be adjusted (e.g., based on the image characteristic data and/or paste prediction parameter(s)), such as one or more of a visual (e.g., a display or light), audible (e.g., an audible alarm) or other sensory indication.

Methods for producing and analyzing carbon pastes are also provided and may include many of the above concepts. In one aspect, a method includes the steps of mixing a particulate carbonaceous material with a carbonaceous binder, thereby creating a carbonaceous paste, obtaining an image of the paste, producing image characteristic data based on the image, and analyzing the image characteristic data to determine characteristic of the carbonaceous paste. The method may further include the step of adjusting an operation parameter associated with the production the carbonaceous paste based on the image characteristic data and/or the analysis associated therewith. For example, at least one of a particulate material feed rate, a binder feed rate, and a particle size distribution may be adjusted based on, for instance, one or more of the producing image characteristic data step and/or the analyzing characteristic data step. In one embodiment, the image characteristic data includes data associated with at least one of paste particle size, paste particle shape, and paste particle light reflectivity/absorptivity, and the operation parameter is at least one of a particulate material feed rate, a binder feed rate, and a particle size distribution.

The obtaining the image step may be accomplished in any suitable manner. For example, the obtaining step may include utilizing an imaging device. The imaging device may be a digital photographic device. To facilitate obtaining of the image, the method may include the step of directing, concomitant to the obtaining an image step, light toward the carbonaceous paste. The light may be any suitable electromagnetic radiation. In one embodiment, the light comprises at least one of infrared, visible and/or ultraviolet light. For example, the light may have a wavelength of from about 280 nm to about 1,000 nm.

The producing image characteristic data step may include a variety of sub-steps to facilitate the producing of the image characteristic data. For example, the producing image characteristic step may include the step of automatically analyzing the obtained image and outputting image characteristic data.

The analyzing the image step may include the step of performing a blob analysis on one or more images. The analyzing step may include the step of correlating present or historical image characteristic data and/or operational data to determine a paste prediction model and/or output a predicated paste parameter. In response to the comparing step, an operation parameter may be adjusted, the operation parameter being associated with production of the carbonaceous paste. Hence, responsive paste evaluation is facilitated.

### BRIEF DESCRIPTION OF THE DRAWINGS

FIG. 1 is a schematic illustration of one embodiment of a system useful in accordance with the present invention.

FIG. 2 is a schematic illustration of one embodiment of the paste control system of FIG. 1.

FIG. 3 is a flow chart illustrating one embodiment of a method for producing a carbonaceous paste in accordance with the present invention.

FIG. 4 is a flow chart illustrating one embodiment of a method of assessing a carbonaceous paste in accordance with the present invention.

FIG. 5 is a graph illustrating test results of an image analysis comparing a predicted percentage of pitch in the paste versus an actual percentage of pitch in the paste.

FIG. 6 is a graph illustrating the individual test run results of FIG. 5.

### DETAILED DESCRIPTION OF THE INVENTION

Reference will now be made in detail to the accompanying drawings, which at least assist in illustrating various pertinent embodiments of the present invention.

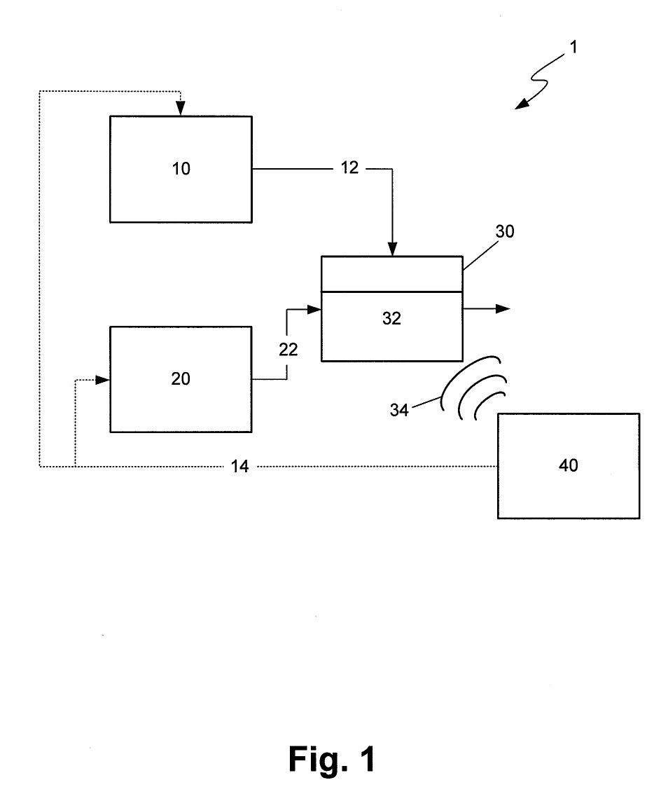

Referring now to FIG. 1, one embodiment of a system 1 for producing a carbonaceous paste is provided, the system 1 comprising a particulate carbon source 10, a carbonaceous binder source 20 and a mixer 30. Particulate carbonaceous material 12 from the particulate carbon source 10 and carbonaceous binder 22 from the carbonaceous binder source 20 are provided to the mixer 30 to make a carbonaceous paste 32. The materials used to produce carbonaceous pastes for use in producing electrodes, either pre-baked or Soderberg-style, are well-known in the art. Hence, any suitable carbon particulate may be utilized in the particulate carbonaceous metal 12, and any suitable carbon-based binders may be utilized for the carbonaceous binder 22. In one embodiment, the particulate carbonaceous material 12 is a particulate material containing a relatively large amount of carbon, such as, for example, coke (e.g., petroleum coke), recycled electrode materials, anode paste scrap and recycled aluminum electrolytic cell sidewall materials, to name a few. In one embodiment, the carbonaceous binder 22 is a binder containing a relatively large amount of carbon, such as coal tar pitch, petroleum pitch, non-graphitic carbon and the like.

A paste control system 40 is provided for analyzing the paste 32. As discussed in further detail below, the paste control system 40 is operable to obtain one or more images of the carbonaceous paste 32 via electromagnetic radiation 34 and output image characteristic data based thereon. For example, an imaging device (e.g., a digital photographic device) may be utilized to obtain an image (e.g., a digital image) of the carbonaceous paste. Thereafter, image characteristic data may be output based on the image(s). The paste control system 40 may be further operable to analyze the image characteristic data to evaluate the paste 32. In one embodiment, the paste control system 40 is operable to adjust an operation parameter associated with the system 1 to adjust the characteristics of the paste 32. For example, the paste control system 40 may be electrically interconnected to control components of the particulate carbon source 10 and/or the carbonaceous binder source 20 (e.g., valves, flow meters, pumps) via a wireless or wired electrical connection 14. In turn, the paste control system may adjust the feed rate of the particulate carbonaceous material 12 or the feed rate of the carbonaceous binder 22 via the electrical connection 14 to adjust the characteristics of the paste 32 based on the analyzed image characteristic data. In one embodiment, the paste control system 40 may be electrically interconnected to the mixer 30 (connection not illustrated) to control an operation parameter associated therewith (e.g., binder feed rate, particulate feed rate, particle size distribution, or mixing speed/rate).

The paste control system 40 may obtain one or more images to evaluate the paste 32. For example, the paste control system 40 may obtain a plurality of images of the paste 32 during the mixing process, as the paste exits the mixer 30, or after the paste exits the mixer 30 to facilitate evaluation of the paste 32. In one embodiment, the imaging device is oriented to capture images of the paste 32 as the paste exits the mixer 30 (e.g., via a waterfall configuration). Upon production of the paste 32, at least a portion of the paste 32 may be utilized in an electrode production step, such as an electrode forming step and/or a baking step.

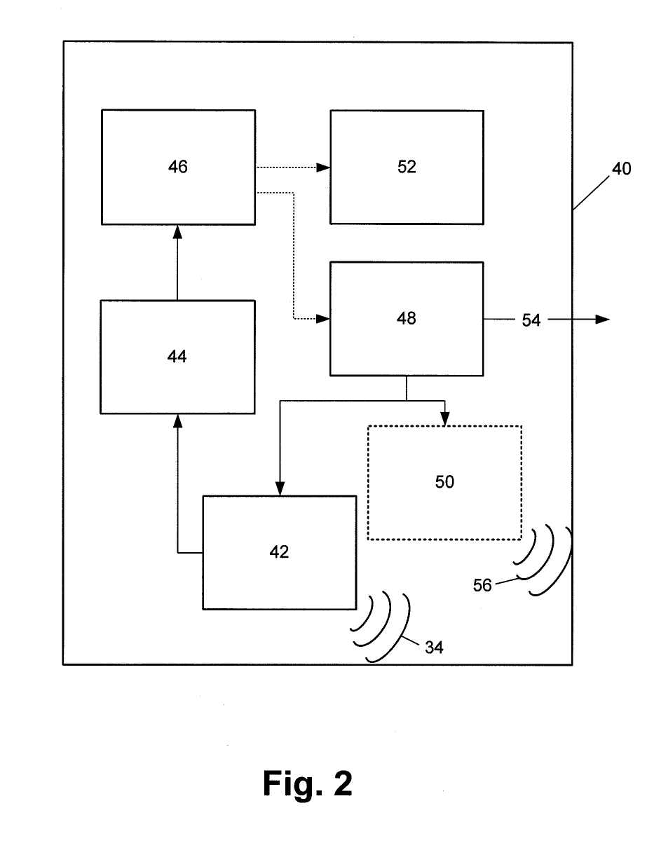

One embodiment of a paste control system is illustrated in FIG. 2. The paste control system 40 includes an imaging device 42, an image processor 44, and a data analyzer 46. The paste control system 40 may optionally include a controller 48, a light source 50 and/or a display 52. The imaging device 42 is operable to obtain images of the paste 32, and, in the illustrated embodiment, the imaging device 42 is interconnected to the image processor 44. The image processor 44 is operable to process the obtained images to determine and output image characteristic data associated with the images. The data analyzer 46 is electrically interconnectable with the image processor 44 and is operable to receive and analyze the image characteristic data. Thus, the paste control system 40 is operable to obtain one or more images of the paste 32 and analyze those images to determine an appropriate control response (e.g., adjust a feed rate, maintain current operation parameters). In one aspect, the control response may be an automated response. In another aspect, the control response may be a manual response.

The imaging device 42 may be any device operable to capture images utilizing electromagnetic radiation 34, such as a photographic device, a scanner, and an x-ray device, to name a few. The imaging device 42 may operate using digital or analog technology. Digital photographic devices are generally preferred as such devices may obtain images in a binary data format that is readily processed by the image processor 44. Indeed, in one embodiment, the image processor 44 and imaging device 42 may be integrated in a single device. In another embodiment, the image processor 44, the data analyzer 46, and the imaging device 42 are integrated in a single device. The imaging device 42 may obtain any of several image styles, such as black and white images, color images, infrared images, UV images, and x-ray images and combinations thereof, to name a few, to facilitate analysis of the paste.

A lens (not illustrated) may be employed with the imaging device 42. The lens should facilitate capturing of images that provide useful image characteristic data. Thus, the lens may facilitate capturing of images that provide a macroscopic field of view of the paste 32. The imaging device 42 is generally positioned proximal the paste 32 to facilitate obtaining the images and is positioned with the lens of the imaging device 42 directed toward the paste 32. The distance from the lens to the object, in this case the paste, is generally known as the object distance. The object distance between the imaging device 42 and the paste 32 is application specific. However, the object distance should be sufficient to obtain a macroscopic view of at least a portion of the paste 32. In one embodiment, the object distance is at least about 0.5 inches, such as at least about 6 inches, or at least about 12 inches, or at least about 18 inches, or at least about 24 inches. In a related embodiment, the object distance is not greater than 96 inches, such as not greater than about 72 inches, or not greater than about 60 inches, or not greater than about 48 inches.

The image area produced by a camera and lens combination at a specific object distance is generally known as the field of view. The field of view is application specific and is related to the object distance, but the field of view should provide a macroscopic image of the paste. In one embodiment, the obtained images should have a field of view of at least 0.125 inches. In a related embodiment, the field of view is not greater than 24 inches. One useful field of view is one that encompasses approximately 3 inches by approximately 2.5 inches of the paste as viewed from an object distance not greater than 4 meters, such as at an object distance of not greater than 1 meter.

The image processor 44 is operable to process the images from the imaging device 42 and output image characteristic data based thereon (e.g., binary data). The image processor 44 may be a device separate from the imaging device 42, or the image processor 44 may be included with the imaging device 42. The image processor may utilize commercially available image processing software.

In one embodiment, the image processor 44 may complete a “blob analysis.” A blob analysis allow identification and measurement of aggregated regions of pixels (blobs) within a grayscale image. Once these regions are identified, various types of analyses may be carried out to characterize the blobs. Some examples include: calculating selected blob features, discarding regions not of interest, and classifying regions according to feature values. The basic steps for performing a blob analysis include acquiring an image, using enhancement operations on the image to prepare it for blob analysis, making the blobs clearly identifiable, generally using a segmentation procedure, selecting blobs within the features to be calculated, selecting the features to calculate, calculating the features, and/or analyzing the results. With respect to selecting the features to be calculated, there are many different parameters that can be utilized to describe the blob features. Some useful blob features with respect to image analysis of carbon pastes are listed in Table 1, below, in no particular order.

TABLE 1
Useful Blob Features

| Blob Features | General Description |
|---|---|
| Area | the number of foreground pixels in a blob |
| CogX, CogY | “center of gravity” in X and Y coordinates respectively, |
| | also called “centroid” |
| Compactness | perimeter/(area × 4π); a measure of how close the pixels |
| | are to one another; a circle has the highest compactness value |
| | of any shape |
| Convex Perimeter | perimeter of smallest enclosing shape |
| Max Radius | the maximum radius of a blob using the centroid as an endpoint |
| Ixx, Iyy, Ixy | a property of a two dimensional shape with respect to an |
| | axis, usually through the centroid of the shape; moments |
| | of inertia in the x, y, and x-y directions can be scaled to |
| | variances and the x-y covariance |
| I1, I2 | major and minor moments of inertia |
| Aspect Ratio | I2/I1 |
| Length | returns a measure of the true length of an object |
| Perimeter | length of the blob outline |
| Roughness | perimeter/convex perimeter; a measure of the unevenness |
| | or irregularity of the blob's surface |
| Median | median image intensity prior to linear intensity transform |
| Elongation | (total skeletal length)/(mean width) = aspect ratio |
| | ignoring gross curvature; e.g., a snake has a high |
| | elongation regardless of how it “lies” |
| FeretX, FeretY | the caliper dimension of a blob in the cartesian X or Y |
| | direction; the dimensions of the minimum bounding box |
| | of a blob in the horizontal and vertical dimensions, respectively |
| Feret Diameter | the diameter of a blob at a given angle |
| FeretMaxDiameter | the largest feret diameter of a blob measured through the |
| | center of gravity, selected from all possible feret angles |
| FeretMinDiameter | the smallest feret diameter of a blob measured through |
| | the center of gravity, selected from all possible feret angles |
| FeretMeanDiameter | the average feret diameter of a blob, through the center of gravity, |
| | at all the angles checked |
| FeretMaxAngle | the angle at which the maximum feret diameter is found |
| FeretMinAngle | the angle at which the minimum feret diameter is found |
| Feret Elongation | FeretMaxDiameter/FeretMinDiameter |

With particular respect to the carbon paste, blob features that facilitate determination of particles relative to paste may be employed. In a particular embodiment, the blob features utilized in the image analysis facilitate generation of image characteristic data relating to at least one of particulate size, particulate shape, and the reflectivity/light absorptive capacity of the particles. In this regard, any of the above-described blob features may be utilized to facilitate approximation of the particle size, particle shape and/or particle reflectivity/light absorptivity. As discussed in further detail below, the image characteristic data that is collected based on the blob features may thus be analyzed to approximate one or more properties of the paste. Hence, the image processor 44 is generally operable to output one or more image characteristic data based on the obtained images to facilitate approximation of the properties of the paste 32.

The data analyzer 46 is electrically interconnectable to the image processor 44 and is operable to analyze the image characteristic data to facilitate approximation of the paste properties and/or determination of an appropriate control response. For example a digital interface, such as a IEEE-1394 compliant digital interface may be used to electrically interconnect the data analyzer 46 to the image processor 44 and/or the imaging device 42. The data analyzer 46 may be, for example, a computerized device, such as a general purpose computer comprising hardware and software that enables the computerized device to receive the image characteristic data and perform calculations based thereon. Upon receipt of the image characteristic data, the data analyzer 46 may analyze one or more of the image characteristic data to facilitate evaluation of the paste (e.g., approximation of the paste properties) and/or determination of the appropriate control response. In one embodiment, the data analyzer 46 may analyze image characteristic data for a plurality of images to facilitate evaluation of the paste and/or determination of the appropriate control response.

With respect to evaluation of the paste, the data analyzer 46 may correlate one or more of the image characteristic data for one or more images to form a paste prediction model and/or output a predicted paste parameter. The paste prediction model may utilize image characteristic data such as current and/or historical image characteristic data and/or other data to develop a model that may utilize current or future image characteristic data to evaluate the paste (e.g., to predict one or more physical properties of the paste). In one embodiment, the paste prediction model is developed using one or more of partitioning, stepwise regression and response-surface modeling statistical analysis techniques. In one embodiment, the paste prediction model utilizes a plurality of the image characteristic data and other data to develop the model. The image characteristic data may be used to develop the model and the other data may be used to develop and/or verify the model. For example, image characteristic data may be correlated to develop a prediction tool for predicting a physical property of the paste. The other data may be used to verify whether the prediction tool is sufficiently accurate.

In one embodiment, the image characteristic data is based on one or more of the blob features described above (Table 1). In one embodiment, the image characteristic data comprises a plurality of historical data based on the blob features. In one embodiment, the other data is data associated with the carbonaceous particulate material and/or the carbonaceous binder. For example, physical measurements of the binder and/or particulate may be utilized as the other data in the paste prediction model. In another approach, the other data is data associated with the production process of the electrode, such as data associated with the production time, temperature, pressure and quality of the electrodes achieved utilizing the paste. Hence, the paste prediction model utilizes at least some image characteristic data to provide a model that facilitates evaluation of the paste.

Utilizing the paste prediction model, the data analyzer 46 may utilize image characteristic data to output a paste prediction parameter. The predicted paste parameter may be any physical properties relating to the paste, such as properties relating to the particulate, the binder or the paste itself. For example, the paste properties may be the percentage amounts of particulate and/or binder within the paste. In another instance, the paste properties may be related to the density, light absorptivity, color, and/or viscosity of the paste, to name a few.

In one embodiment, the data analyzer 46 may receive image characteristic data based on one or more of the above-described blob features. In turn, the data analyzer 46 may utilize this image characteristic data in conjunction with the paste prediction model to output a predicted paste property, such as weight percentages of the particular and/or binder within the paste, or other suitable paste properties. In a particular embodiment, the data analyzer 46 calculates a predicted ratio of carbonaceous binder to particulate carbonaceous material based on the image characteristic data utilizing the paste prediction model. In this embodiment, the paste prediction model may be formed by utilizing the following formula:

a0+a(1)*f1+a(2)*f(2)+ . . . a(n)*f(n)

where n is the number of linear terms used in the model, which may be determined by application of a stepwise regression to the image characteristic dataset(s), where a0=an intercept, where a(1), a(2) . . . a(n) are linear coefficients estimated by ordinary least squares regression, and where f(1), f(2) . . . f(n) are statistical summaries of one or more image characteristic data. In one embodiment, the statistical summary includes, in no particular order, at least one of the following statistics for at least one of the image characteristic data:
Mean
Median
Standard deviation
Range
Coefficient of variation (standard deviation/mean)
1st quartile (i.e., 25% quantile, the value that exceeds 25% of all values)
3rd quartile (i.e., 75% quantile)

Once developed, the paste prediction model may be utilized with new or additional image characteristic data to evaluate pastes. In one embodiment, the data analyzer 46 uses the image characteristic data with the paste prediction model to predict a ratio of binder to particulate in the paste. The data analyzer 46 may compare the predicted ratio of binder to particulate to a desired range of the ratio of binder to particulate. For example, for pre-baked anodes the acceptable range of the ratio of binder to pitch may be from about 13% to about 18% binder, and correspondingly from about 87% to about 82% particulate. For Soderberg anodes, the suitable range of the ratio of binder to particulate may be from about 24% to about 32% binder, and correspondingly, from about 76% to about 68% particulate. If the predicted ratio obtained from the image characteristic data and paste prediction model is within the desired range parameters, no changes may be needed with respect to paste production. If the predicted ratio is outside of the desired range parameters, an operation parameter may be adjusted. The paste prediction model may be static or may be dynamically adjusted based on received image characteristic data and/or other data.

The output paste prediction parameter(s) may be utilized in a variety of ways. For example, the paste prediction parameter(s) may be provided to the controller 48 for use in controlling paste operations. The controller 48 may be interconnectable with at least the data analyzer 48 and operable to output control parameters to control the production of the paste 32. For example, the controller 48 may send signals (e.g., via connection 54) to the particulate carbon source 10 and/or the carbon binder source 20 to facilitate an appropriate adjustment to the feed rate of those sources based on received paste prediction parameters. The controller 48 may be, for example, a computerized device operable to send signals to one or more of the carbon sources 10, 20, the imaging device 42 and/or the light source 50. The controller 48 and data analyzer 46 may be integrated in a single computerized device.

In another approach, the paste prediction parameter(s), image characteristic data and/or a suggested control response may be displayed via the display 52, which may be electrically interconnected to the data analyzer. In one embodiment, a sensory indication (e.g., a visual, audible, and/or olfactory indication) may be provided by the paste control system 40 to alert an operator with respect to the operating conditions of the paste production system 1. For example, an audible alarm, a light, or other indicator may be triggered if the paste prediction parameter and/or image characteristic data indicates that the physical properties of the paste may be outside of tolerable production limits/ranges. In one embodiment, an operator may view one or more of the paste prediction parameter(s), image characteristic data and/or a suggested control response via the display 52 and then take appropriate action.

As noted, the controller 48 may be electrically interconnectable to the imaging device 42 and/or the optional light source 50 to facilitate obtaining of the images. For example, the controller 48 may coordinate operation of the light source 50 and the imaging device 42 to obtain consistent image lighting. In one embodiment, the controller 48 may send signals to the light source 50 to trigger and direct light toward the paste. Concomitant to triggering the light source 50, the controller 48 may activate the imaging device 42 to obtain one or more images of the paste with consistent background lighting. In one embodiment, natural lighting may be used in lieu of the light source 50.

The optional light source 50 may be utilized to direct light toward the paste 32. For example, the light source 50 may be operable to direct electromagnetic radiation 56 having a wavelength in the ultraviolet (e.g., 280-400 nm), visible (e.g., 400-700 nm), and/or infrared wavelength ranges (e.g., 700 nm-1,000 nm) toward the paste 32. In this regard, the light source 50 is generally located proximal the mixer 30. For example, the light source 50 may be positioned near the outlet of the mixer 30, for example, perpendicular to the outflow of the paste 32 (e.g., in a waterfall configuration where the exiting paste 32 flows onto a conveyor to an electrode preparation apparatus). Use of the light source 50 may increase the repeatability and reliability of the obtained images by providing consistent background light. In one embodiment, the optional light source 50 is activated concomitant to obtaining of the image. The amount of time between the activation of the light source 50 and the obtaining of the image is application specific, and will be based on, for example, the distances between the imaging device 42, the light source 50 and the paste 32. The time between the activation of the light source 50 and the obtaining of the image may be adjusted to as appropriate utilizing techniques known to one skilled in the art. The light source 50 may include one or more light sources, such as a plurality of bulb-based lights.

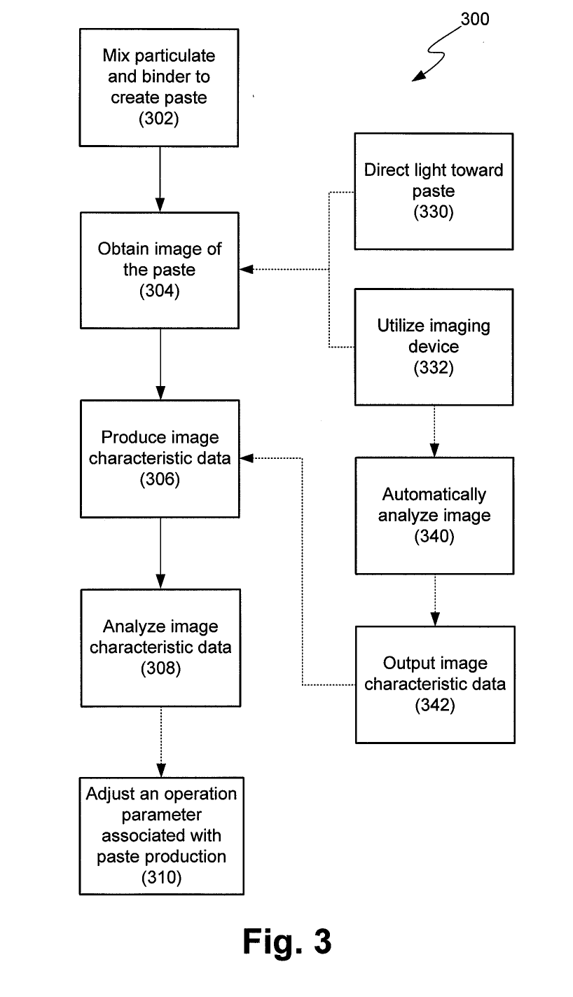

Methods of producing a carbon paste are also provided. One embodiment of a method for producing a carbon paste is illustrated in FIG. 3. The method 300 includes the steps of mixing a particulate carbonaceous material with a carbonaceous binder to create a carbonaceous paste 302, obtaining one or more images of the carbonaceous paste 304, producing image characteristic data based on the images 306, and analyzing the image characteristic data 308. The method may also include the step of adjusting an operation parameter associated with the production of the carbonaceous paste 310.

The mixing step 302 may be completed using particulate carbonaceous material and the carbonaceous binder, and the mixing may be accomplished with any suitable technology, such as via a mixer 30, as described above with reference to FIG. 1. The obtaining of one or more images of the carbonaceous paste step 304 may be accomplished using any suitable technology, such as via an imaging device and, optionally, a dedicated light source, as described above. The method 300 may include the steps of directing light toward the paste 330 and, concomitant to the directing light step 330, utilizing an imaging device to obtain the image of the paste 332. Generally, the obtained images should provide a macroscopic view of the paste to facilitate analysis of the image characteristic data relative to the properties of the paste. In this regard, the systems described above with reference to FIG. 1 may be utilized.

The producing image characteristic data step 306 may be accomplished via, for example, an image processor that outputs image characteristic data based on the images. In one embodiment, the obtained images may be in a binary data format and the binary data associated with the images may be supplied (e.g., via electrical communication) to the image processor for evaluation and output of image characteristic data. In one embodiment, the image characteristic data is based on a blob analysis and includes data based on one or more of the blob features provided in Table 1, above.

In one embodiment, the method may include the step of automatically analyzing the image 340 concomitant to obtaining the image step 304. For example, upon utilizing the imaging device 332, the image and/or the data associated therewith (e.g., binary imaging data) may be automatically provided to an image processor, which may automatically analyze the image and/or the data and output the image characteristic data 342.

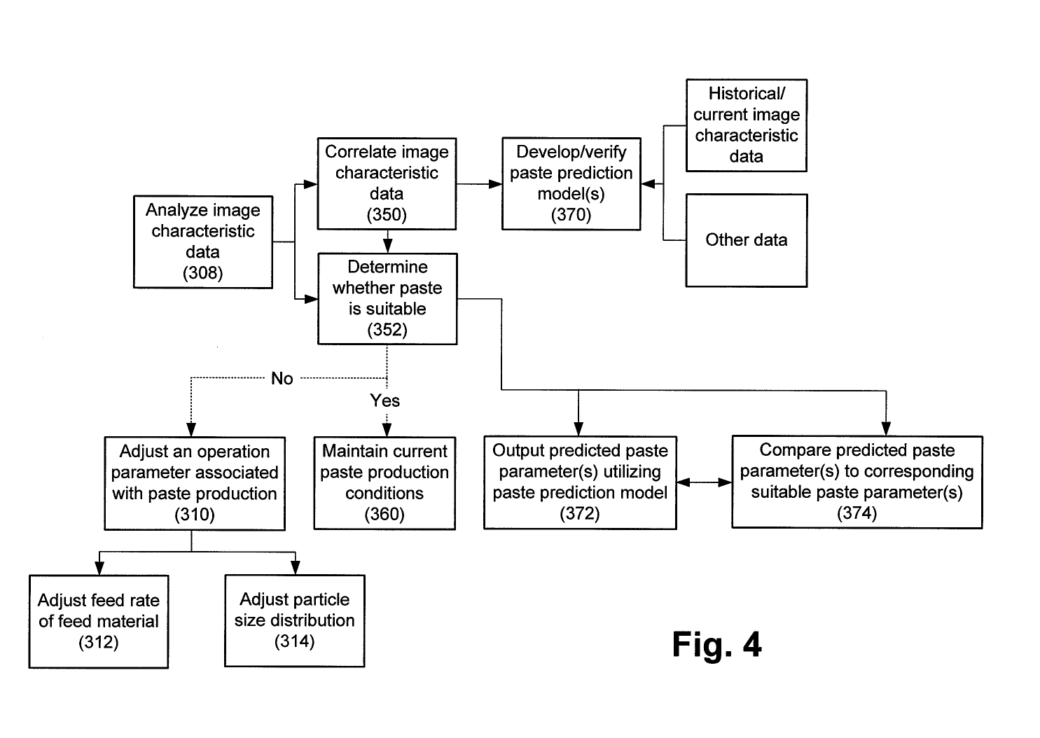

Referring now to FIGS. 3 and 4, the analyzing image characteristic data step 308 may be accomplished via any suitable technology, such as a computerized device (e.g., a general purpose computer). The image characteristic data may be analyzed to evaluate the paste and/or assess whether an operation parameter associated with the production of the paste should be adjusted. For example, at least some of the image characteristic data may be correlated 350 to facilitate determination of whether the carbonaceous paste is suitable 352. In a particular embodiment, a paste prediction model is developed 370 based at least in part on image characteristic data, historical or current. In one embodiment, other data, such as physical properties data associated with the feed materials, the paste and/or the electrode, may be utilized to assist in developing, maintaining and/or verifying the paste prediction model. To evaluate the paste, image characteristic data may be input into the paste prediction model, and one or more paste prediction parameter(s) may be output 372. In turn, the predicted paste prediction parameter(s) may be compared to suitable paste parameter(s) to evaluate the paste and/or determine whether the paste is suitable 374. For example, a weight percent of binder in the paste may be output as the predicted paste parameter and this weight percent may be compared to a known suitable binder weight percent range. If the predicted weight percent is within the suitable range, the paste may be determined to be suitable. Likewise, if the predicted weight percentage is outside the suitable range, the paste may be determined to be unsuitable. Other paste prediction parameters may also/alternatively be employed. In one embodiment, a plurality of predicted paste parameters are utilized, and a hierarchical/weighing methodology is employed to accord various prediction parameters differing degrees of importance when evaluating the paste.

If the analysis step 308 suggests that the paste is suitable (e.g., suitable for production of a green electrode and/or a baked electrode), current paste production conditions may be maintained 360. If the analysis step 308 suggests that the paste is unsuitable or may soon become unsuitable, one or more operation parameters associated with the production of the paste may be adjusted 310. For example, a feed rate of at least one feed material may be adjusted 312. The feed material may be the particulate carbonaceous material or the carbonaceous binder. Additionally or alternatively, other operational parameters may be adjusted 314, such as particle size. The obtaining an image 304, producing image characteristic data 306 and analyzing the image characteristic data 308 steps may be repeated, as necessary, to facilitate evaluation and production of the carbonaceous paste.

### EXAMPLES

### Example 1

### Development of Paste Prediction Model and Paste Analysis System

A paste analysis system was configured to analyze a paste utilized to make pre-baked anodes. A Sony Digital Video Camera (Sony Corporation, 7-35 Kitashinagawa 6-chome, Shinagawa-ku, Tokyo, 141-0001 Japan), a photo lens from COMPUTAR (CBC America Corp., 55 Mall Drive, Commack, N.Y. 11725), and strobe lights from Advanced Illumination, Inc. (24 Peavine Drive, Rochester VT 05767) were employed. Imaging software from Media Cybernetics, Inc. (4340 East-West Hwy, Suite 400, Bethesda, Md., USA) and Matrox Electronic Systems Ltd. (1055 St. Regis Blvd., Dorval, Quebec H9P 2T4, Canada) were utilized. The camera lens was approximately 15 inches above the sample anode paste. The strobe lights were approximately 20 inches above the sample anode paste and approximately 15 inches apart. The strobe lights were angled toward the center of the field of view at an angle approximately 70 degrees below the horizontal. The field of view was approximately 3 inches by approximately 2.5 inches.

Ninety-three images of anode paste were collected. A blob analysis for each of the images was completed to locate particles and then to approximate the size, shape and shininess of the particles within the paste. In particular, blobs were defined as:
1. The intensity range is linear so that the min=0 (black), and max=255 (white).
2. Optional: The image may be smoothed using a small-kernel spatial filter, such as 3×3-pixel median or Gaussian filter.
3. A threshold, T, is selected—either fixed (e.g., at 128), or dynamically based on the image (e.g., median(intensity)).
4. T is applied to binarize the image—i.e., convert it to simple black and white: each pixel with a grayscale value <T becomes black (0), and every other pixel becomes white (255).
5. Blobs are identified as groups of neighboring white pixels, where a neighbor is defined as a single king's move in chess.
6. Blobs that have pixels on the border of the image are excluded.
7. Omit all blobs with fewer than k pixels, where “k” is a threshold relating to the noise in the image.
8. The final result is that a typical anode paste image (of ˜10⁶ pixels) will have many blobs: tens, hundreds, or even several thousand.

For each blob, image characteristic data based on the blob features of Table 1 were determined. Summary statistics were computed based on image characteristic data, the statistics including: mean, median (i.e., 2^{nd} quartile=50% quantile, the value that exceeds 50% of all values), standard deviation, range, coefficient of variation (standard deviation/mean), 1^{st} quartile (i.e., 25% quantile, the value that exceeds 25% of all values), and 3^{rd} quartile (i.e., 75% quantile).

Three empirical methods (partitioning, stepwise regression, and response-surface modeling) were used to identify prediction models that can be used to predict the change in percent pitch (Δpitch) to within +/−0.5% at 95% confidence. Partitioning and stepwise regression were used to help narrow the list of factors to those that are most effective (as a group) at predicting the percent of pitch in the paste or the predicted change in the percent of pitch in the paste. Response-surface modeling was then used with stepwise regression for the remaining factors to determine the linear effects as well as the effect of squared (i.e., quadratic) terms and interactions among the factors.

The resultant linear model utilized the product of each of the estimated coefficients and terms in Table 2 in an additive fashion to obtain the estimated percentage of pitch in the paste via the following specific prediction formula:

Predicted weight pitch in the paste=a0+(−419.2292)*Mean(FeretY)+(−30.04526)*Mean(FeretElongation)+(−61.28954)*Mean(AspectRatio)+(83.442555)*Mean(Roughness)+(24.207813)*Median(AspectRatio)+(2063.1436)*Quantiles25(MaxRadius).

TABLE 2
Statistical Factors Used to Estimate The Percentage of Pitch
In The Paste Based on Image Statistics from Example 1.

| | Estimated | | | |
|---|---|---|---|---|
| Term | Coefficient | Std Error | t Ratio | Prob > \|t\| |
| Mean (FeretY) | −419.2292 | 71.48105 | −5.86 | <.0001 |
| Mean (FeretElongation) | −30.04526 | 10.21568 | −2.94 | 0.0044 |
| Mean (AspectRatio) | −61.28954 | 13.95474 | −4.39 | <.0001 |
| Mean (Roughness) | 83.442555 | 15.7139 | 5.31 | <.0001 |
| Median (AspectRatio) | 24.207813 | 7.86907 | 3.08 | 0.0030 |
| Quantiles25 (MaxRadius) | 2063.1436 | 479.4016 | 4.30 | <.0001 |

A positive (+) sign on the estimates indicate that, as the statistical factor increases, so does the estimate of percent pitch; for example, as pitch is added, the particles get rougher, on average. A negative (−) sign on the estimate indicates that, as the statistical factor increases, the estimate of percent pitch decreases.

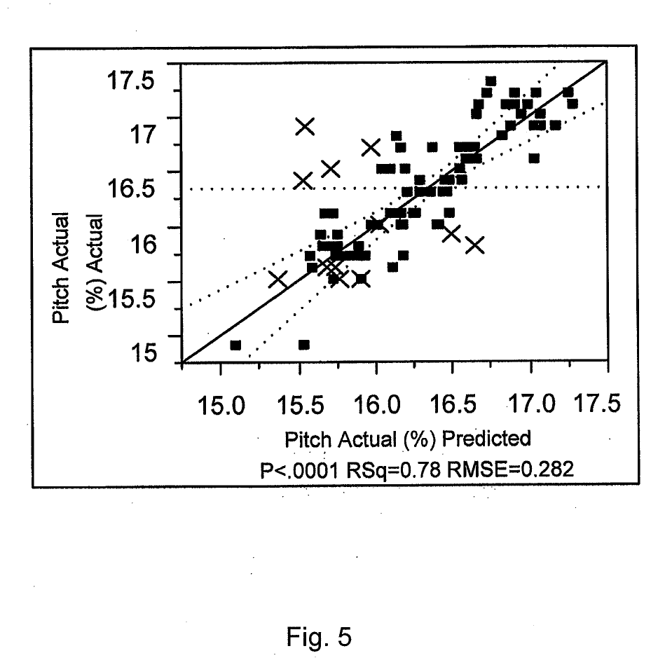

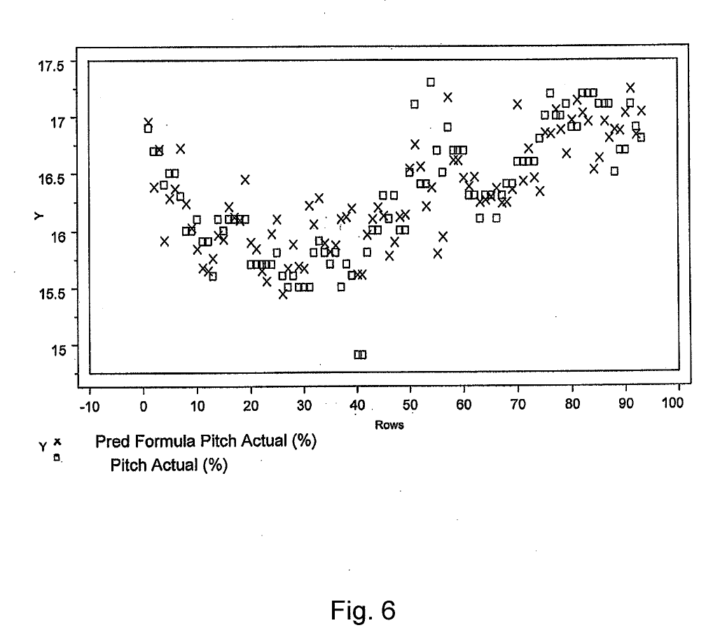

FIG. 5 shows the relationship between actual percent pitch vs. predicted percent pitch, based on the image statistics in the model above. Actual percent pitch in the anode paste was estimated online via physical measurement of the feed materials to the paste. The results show that the correlation has a good fit with an R² of 0.78, a P<0.0001, and RMSE=0.282. The sensitivity of the percent pitch measurement is ±0.5%. The results show the sensitivity is above the criteria for percent pitch of ±1.0% for excursion prevention. FIG. 6 shows the actual percent pitch (in squares) and the predicted percent pitch (in x's) for 93 runs.

While the present invention has generally been described in relation to evaluation of a carbonaceous paste, the teachings provided herein may also be applied to other aspects of carbon electrode production. For example, images of feed materials, the green electrode and/or the baked electrode may be obtained and analyzed as provided herein to facilitate control of one or more aspects of carbon electrode production. Furthermore, these imaging and analysis techniques may also be employed in other multi-phase liquid production systems, such as in other paste-type production systems. Moreover, while various embodiments of the present invention have been described in detail, it is apparent that modifications and adaptations of those embodiments will occur to those skilled in the art. However, it is to be expressly understood that such modifications and adaptations are within the spirit and scope of the present invention.

What is claimed is:

1. A method for analyzing a carbon paste, the method comprising:
mixing a particulate carbonaceous material with a carbonaceous binder, thereby creating a carbonaceous paste;
obtaining an image of the carbonaceous paste;
producing image characteristic data based on the image; and
analyzing the image characteristic data, thereby determining characteristics of the carbon paste.

2. The method of claim 1, further comprising:
adjusting an operation parameter associated with production of the carbonaceous paste, the operation parameter comprising at least one of a particulate material feed rate, a binder feed rate, and particle size distribution.

3. The method of claim 1, wherein the image characteristic data comprises data relating to at least one of paste particle size, and paste particle shape.

4. The method of claim 1, wherein the obtaining step comprises:
utilizing an imaging device.

5. The method of claim 4, wherein the imaging device is a digital photographic device.

6. The method of claim 1, wherein the producing step comprises:
automatically analyzing the image and outputting the image characteristic data.

7. The method of claim 6, wherein the analyzing step comprises:
comparing the image characteristic data to historical operational data.

8. The method of claim 7, further comprising:
adjusting an operation parameter associated with the production of the carbonaceous paste in response to the comparing step.

9. The method of claim 1, further comprising:
directing, concomitant to the obtaining an image step, light toward the carbonaceous paste.

10. The method of claim 9, wherein the light comprises a wavelength of from about 280 nm to about 1,000 nm.

11. The method of claim 1, wherein the analyzing step comprises
developing a paste prediction model based at least in part on the image characteristic data; and
outputting at least one predicted paste parameter utilizing the paste prediction model.

12. The method of claim 1, wherein the carbonaceous binder comprises pitch.

13. A system for manufacturing a carbonaceous paste for use in producing carbonaceous electrodes, the system comprising:
a mixture tank adapted to contain a carbonaceous paste; and
a paste control system comprising:
an imaging device operable to obtain an image of the carbonaceous paste;
an image processor operable to process the image and output image characteristic data;
a data analyzer electrically interconnectable with the image processor and operable to analyze the image characteristic data and output a predicted paste parameter; and
an indicator for indicating whether to adjust paste production conditions based on at least one of the paste prediction parameter and image characteristic data.

14. The system of claim 13, wherein the predicted paste parameter is a predicted percentage of pitch in the carbonaceous paste.

15. The system of claim 13, wherein the image is in a binary format.

16. The system of claim 13, wherein the imaging device comprises a digital photographic device.

17. The system of claim 16, wherein the digital photographic device comprises the image processor.

18. The system of claim 13, wherein the paste control system comprises:
a light source adapted to direct light toward the carbonaceous paste.

19. The system of claim 18, wherein the light comprises a wavelength of from about 280 nm to about 1,000 nm.

20. The system of claim 13, wherein the predicted paste parameter comprises data relating to at least one of paste particle size and paste particle shape.
